(19) United States
(12) Patent Application Publication
(10) Pub. No.: US 2026/0137571 A1
(43) Pub. Date: May 21, 2026

(54) ENHANCED MULTI-STABLE COMPLIANT MATTRESS FOR PREVENTING PRESSURE INJURIES

(71) Applicants: THE REGENTS OF THE UNIVERSITY OF CALIFORNIA, Oakland, CA (US); K MEDICAL LLC, Porter Ranch, CA (US)

(72) Inventors: Jonathan Brigham Hopkins, Irvine, CA (US); Siyuan Shao, Los Angeles, CA (US); Piyush Sheth, Porter Ranch, CA (US); James Langer Weida, Poway, CA (US); Zhidi Yang, Poinciana, FL (US)

(73) Assignees: THE REGENTS OF THE UNIVERSITY OF CALIFORNIA, Oakland, CA (US); K MEDICAL LLC, Porter Ranch, CA (US)

(21) Appl. No.: 19/439,424

(22) Filed: Jan. 4, 2026

Related U.S. Application Data
(63) Continuation of application No. PCT/US2024/041833, filed on Aug. 9, 2024.
(60) Provisional application No. 63/518,962, filed on Aug. 11, 2023.

(51) Int. Cl. A61G 7/057

(52) U.S. Cl. CPC A61G 7/0573; A61G 7/05707

(57) ABSTRACT

A mattress apparatus for preventing bed sores is described. The mattress has a plurality of parallel planar panels having an upper member coupled to a base member through a plurality of legs and flexible hinges. Each upper member extends to allow the pitch and amplitude of the mattress to remain regular. A grid of straps is joined to the upper members to keep panels synchronized with one another. The capabilities of the mattress are further advanced by the inclusion of different categories of accessories.

### CROSS-REFERENCE TO RELATED APPLICATIONS

This application claims priority to, and is a 35 U.S.C. § 111(a) continuation of, PCT international application number PCT/US2024/041833 filed on Aug. 9, 2024, incorporated herein by reference in its entirety, which claims priority to, and the benefit of, U.S. provisional patent application Ser. No. 63/518,962 filed on Aug. 11, 2023, incorporated herein by reference in its entirety. Priority is claimed to each of the foregoing applications.

The above-referenced PCT international application was published as PCT International Publication No. WO 2025/038495 A2 on Feb. 20, 2025, which publication is incorporated herein by reference in its entirety.

### STATEMENT REGARDING FEDERALLY SPONSORED RESEARCH OR DEVELOPMENT

This invention was made with Government support under NR019721 awarded by the National Institutes of Health. The Government has certain rights in the invention.

### NOTICE OF MATERIAL SUBJECT TO COPYRIGHT PROTECTION

A portion of the material in this patent document may be subject to copyright protection under the copyright laws of the United States and of other countries. The owner of the copyright rights has no objection to the facsimile reproduction by anyone of the patent document or the patent disclosure, as it appears in the United States Patent and Trademark Office publicly available file or records, but otherwise reserves all copyright rights whatsoever. The copyright owner does not hereby waive any of its rights to have this patent document maintained in secrecy, including without limitation its rights pursuant to 37 C.F.R. § 1.14.

### BACKGROUND

### 1. Technical Field

The technology of this disclosure pertains generally to mattresses for eliminating bed sores, and more particularly to a multi-stable compliant-mechanism mattress.

### 2. Background Discussion

Significant concerns arise for medical care providers in regard to patients that are bedridden for long periods of time, as this can lead to the probable occurrence of bedsores or skin ulcers in areas of the body that are in constant contact with the mattress. Bed sores are caused primarily by the occurrence of increased and constant pressure on the capillaries in the dermis of the skin that results in the prolonged blockage of blood flow. For example, contact pressures exceeding 32 mm of Hg for longer than two hours can cause pressure sores.

In certain cases, patients may develop bed sores within 4 hours to 6 hours if they are not properly and regularly repositioned. The current hospital protocol is to turn the patient every two hours. However, this repositioning requirement not only disturbs and awakens sleeping patients; but it may also cause maceration due to the shear forces experienced by the often fragile and sensitive skin of the patient. Repositioning can also be a liability for the nurses who are tasked with turning a patient who may be overweight and/or otherwise difficult to move.

Previous work provided a mattress system which is effective at limiting the occurrence of pressure ulcers. There remains a need for beneficial enhancements to mattress mechanisms, mattress durability and ease of use of that mattress.

### BRIEF SUMMARY

This disclosure describes an enhanced multi-stable compliant mattress mechanism, in which a plurality of mattress panels are retained by flexure structures in parallel beneath the padding of the mattress. Each mattress panel may comprise a plurality of plastic rigid pieces joined together by flexural hinge members into trapezoidal unit cell geometries, such that as the tops of these trapezoids are shifted in a first direction they form a first checkerboard pattern of hills and valleys, and when the trapezoids are shifted in a second direction they form a complementary second checkerboard pattern of hills and valleys in which the hills are now valleys and the valleys are now hills. By periodically shifting between the first and second positions the pressures applied to the person lying on the mattress are reversed, thus reducing or eliminating the issues with bed sores.

The trapezoidal arrangements of rigid plastic pieces include top bars that are configured to allow extending and contracting along their length thus allowing the hinges to deform over larger ranges without damaging the hinges. In addition, straps pass through each top bar connecting transversely to other mattress panels, wherein the mattress panels are synchronized in their operating between the first and second stable states.

The flexure structures retaining the mattress panels are configured to flex, thus allowing the disclosed mattress mechanism to conform to articulating bedframes.

Additional aspects are described for adjusting the spring tensions of the mattress, as well as for being able to change the mattress from its first and second positions without manual intervention.

Further aspects of the technology described herein will be brought out in the following portions of the specification, wherein the detailed description is for the purpose of fully disclosing preferred embodiments of the technology without placing limitations thereon.

### BRIEF DESCRIPTION OF THE DRAWINGS

The technology described herein will be more fully understood by reference to the following drawings which are for illustrative purposes only:

FIG. 1 and FIG. 2 are pictorial exploded and assembled views of a prior compliant mattress of the inventors containing trapezoidal mechanisms for creating a grid of high and low pressure that can be alternated.

FIG. 3 is a pictorial view of an enhanced compliant mattress mechanism according to at least one embodiment of the present disclosure.

FIG. 4 and FIG. 5 are pictorial views of top bar designs for use within the enhanced compliant mattress mechanism, according to at least one embodiment of the present disclosure.

FIG. 6A through FIG. 6E are pictorial views of a top bar utilizing sliding joints within the enhanced compliant mattress mechanism, according to at least one embodiment of the present disclosure.

FIG. 7A is a pictorial view of an articulating bedframe, to aid in understanding some features of the enhanced compliant mattress mechanism.

FIG. 7B through FIG. 7I are pictorial views of compliant side-flexure structures for retaining mattress panels in a generally perpendicular orientation to the bed, according to at least one embodiment of the present disclosure.

FIG. 8A through FIG. 8D are pictorial views of static balancing springs for adjusting mattress panels for the weight of any occupant toward reducing the force required in switching the mattress between its stable states, according to at least one embodiment of the present disclosure.

FIG. 9 and FIG. 10 are views of additional static balancing springs for adjusting mattress panels for the weight of any occupant, according to at least one embodiment of the present disclosure.

FIGS. 11A and 11B are pictorial views of an electrically driven actuator for the enhanced compliant mattress mechanism, according to at least one embodiment of the present disclosure.

FIG. 12A and FIG. 12B are views of another actuation mechanism making use of linear actuator for the enhanced compliant mattress mechanism, according to at least one embodiment of the present disclosure.

FIG. 13A through FIG. 13C are pictorial views of an independent actuation mechanism for the enhanced compliant mattress mechanism, according to at least one embodiment of the present disclosure.

FIG. 14A and FIG. 14B is a pictorial view of another independent actuation mechanism for the enhanced compliant mattress mechanism, according to at least one embodiment of the present disclosure.

FIGS. 15A and 15B are pictorial views of an air driven pressure tube actuator for the enhanced compliant mattress mechanism, according to at least one embodiment of the present disclosure.

### DETAILED DESCRIPTION

### 1. Introduction

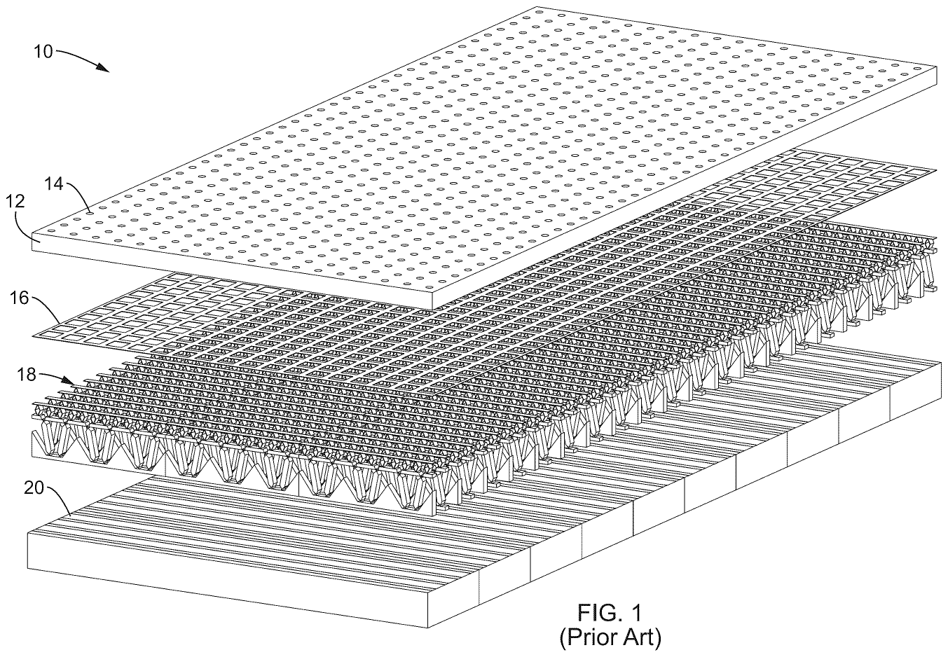

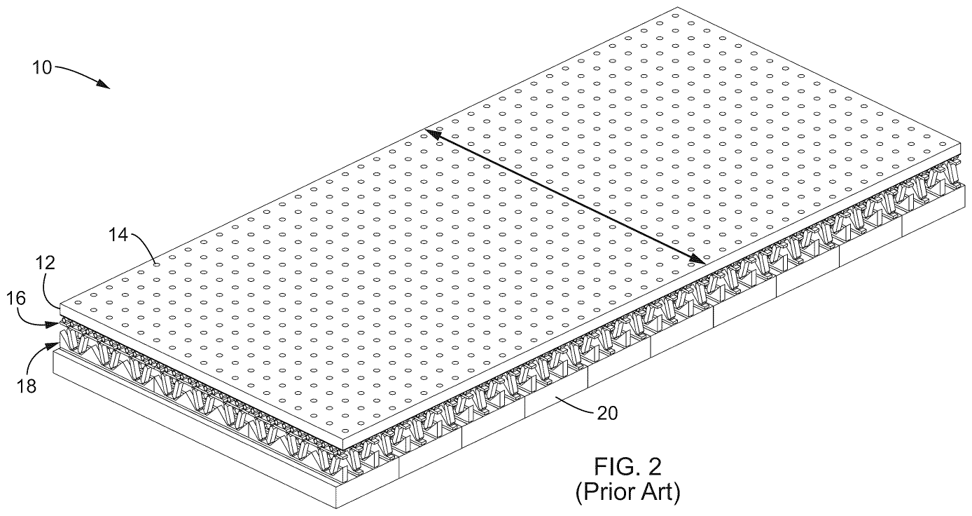

FIG. 1 and FIG. 2 illustrate our previously-developed mattress 10 comprising a foam pad 12 with ventilation holes 14 through it, placed over alternating compliant panels 18 that are stabilized over their top surface by a mesh (grid) 16. The underside of compliant panels 18 are attached to a base member 20 on the bottom. As the mattress panels deform to one side or the other, they create a grid of high and low-pressure points that alternate depending on what side the mattress was deformed.

### 2. Enhanced Compliant Mattress

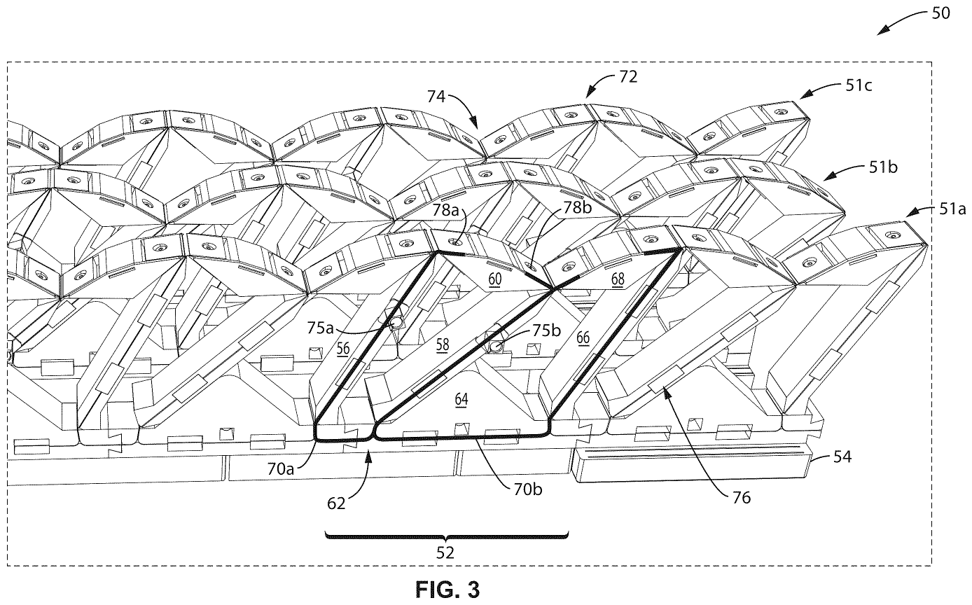

FIG. 3 illustrates an example embodiment 50 of an enhanced compliant mattress mechanism. The mechanism comprises a series of mattress panels which would typically span the width of the bedframe, a portion of which are exemplified in this figure as 51a, 51b and 51c. The mattress panel 51a in the forefront is shown connected into a side flexure element 54, with vertical support removed so that the structure of the panel can be seen. Thus, a sufficient number of these mattress panels would generally be connected in parallel with the side flexures to span the length of the bed area, whereby these mechanism can span any desire area of the bed.

The panels comprise plastic rigid pieces joined together by flexural hinge members (e.g., metal shims) that act as flexures by deforming at the desired rotational hinges. In this way, the hinges can deform over larger ranges and can be loaded with significantly larger transverse forces without leading to hinges failure.

Each mattress panel contains a series of trapezoidal elements, such as seen by cell 52 which is flexibly attached at a base 62. In the figure is shown a first trapezoid formed with a vertical element 56 connected to a top bar 60, joined to an adjacent vertical element 58, which also extends down to base 62. It can also be seen that an adjacent second trapezoid is formed from vertical element 66 being connected between base 62 and a top bar 68, whose opposing side connects to vertical element 58 which was already described. These two trapezoids form a unit cell 52 of the mattress panel. It will be noted that the two adjacent trapezoids share their outer rigid legs with bordering unit cells.

The trapezoids shown in this figure are presently leaning toward the right side of the figure in a first stable state, with peaks 72 and valleys 74 seen across the tops of mattress panels 51a, 51b and 51c. It will be noted that the adjacent panels are shown in this embodiment as being displaced by about one-half the distance between the peaks 72 and the valleys, whereby the top surface has alternating peaks and valleys whether viewed in the longitudinal (x direction), or latitudinal (y direction).

The dark lines 70a and 70b in the figure depict elongate flexural hinge members. Hinge material 70a is shown inserted into slots in base region 62 and passing up through slots in vertical arms 56 and 58, and then slots within top bar 60 within which the flexural hinge member is retained, such as with a fastener and/or a compression structure. It will be noted that in at least one embodiment screws 78a, 78b in the top bar pass through the flexural hinge member, while the body of the top bar may also preferably compress the hinge material to prevent it from wearing on the screw.

Similarly, another piece of flexural hinge material is shown which connects from top bar 68 and through the interiors of vertical elements 58 and 66 and through the portion of base 62, which contains an angular stop 64, which limits the travel of vertical element 58 when the top of this mattress panel is leaning to the right, and which limits the travel of vertical element 66 when the top of this mattress panel is leaning to the left.

In at least one embodiment the flexural hinge material comprises a metal shim material (flexible metal strip), formed (e.g., bent) into the desired shape for loading into the mattress panels. In at least one embodiment, such as in production versions, the shims would be preferably retained in the mold, with the plastic injected into the mold to encase the shim when forming the stiff plastic elements.

In at least one embodiment, when the flexural hinge material is not molded into the stiff plastic elements, additional hinge retention structures 76 are used to assure that the flexural hinge material is retained within the vertical and base elements. For example, in the embodiment of FIG. 3 plugs 76 are used, which are inserted into recesses in the vertical elements and base to retain and prevent the flexural hinge member from shifting out of position. The plug for example in at least one embodiment is rectangular (e.g., cuboid) with a slot, so that when inserted into the base or vertical elements, one half of the plug slides on either side of the hinge material and engages into the respective vertical and base structures. This plug may be formed with a taper so that under compression it tightens upon the hinge material for more secure retention of the plug and hinge material.

By way of example and not limitation, the base member 62 is shown comprising separate interlocking sections, thus allowing any width of mattress panel to be readily created. In at least one embodiment, the base, vertical elements and top bars are fabricated from a rigid plastic material, which may comprise any of a wide range of these materials without limitation. In at least one embodiment, these parts are fabricated by molding, although in the example they were 3D printed.

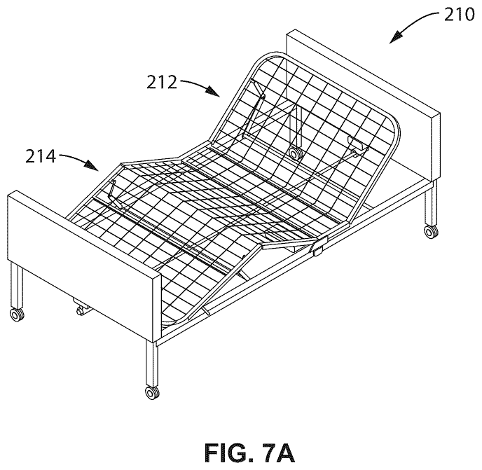

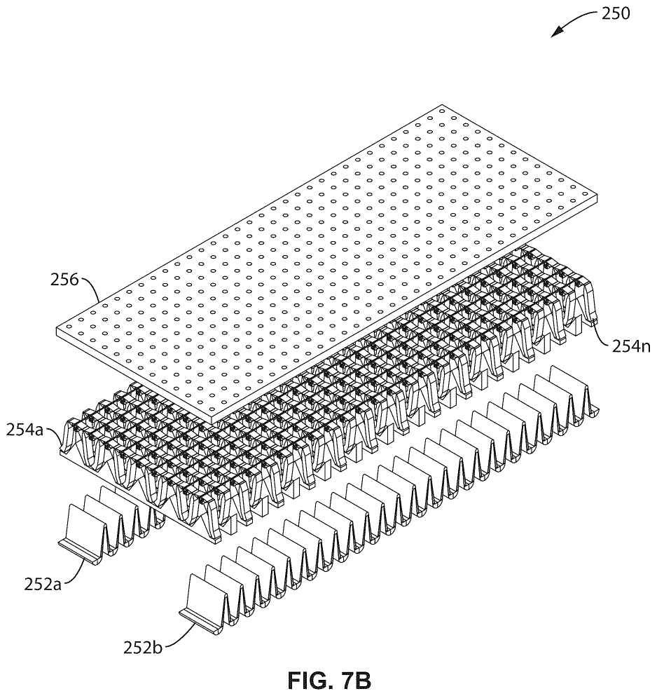

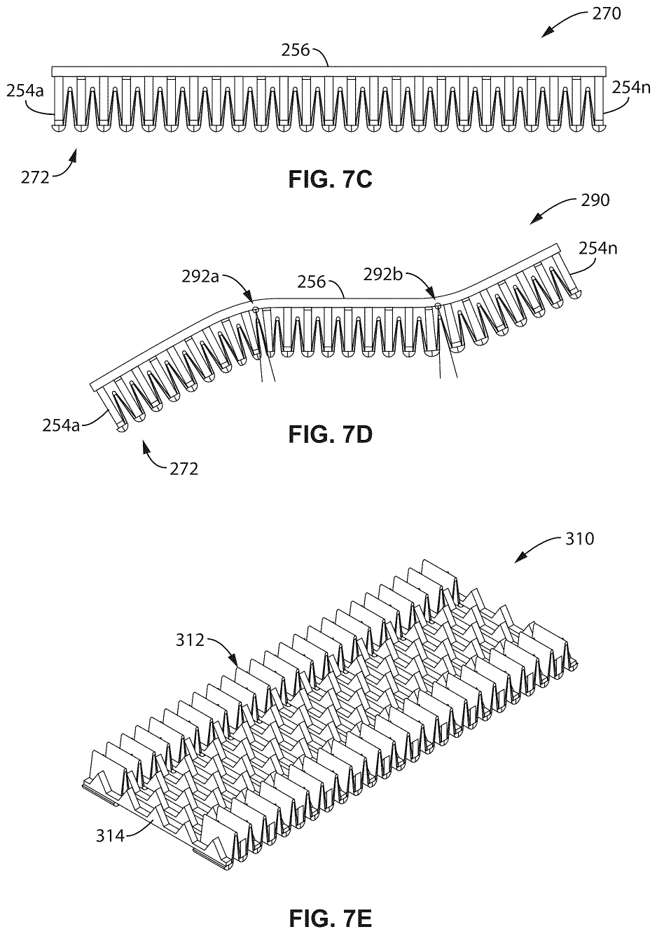

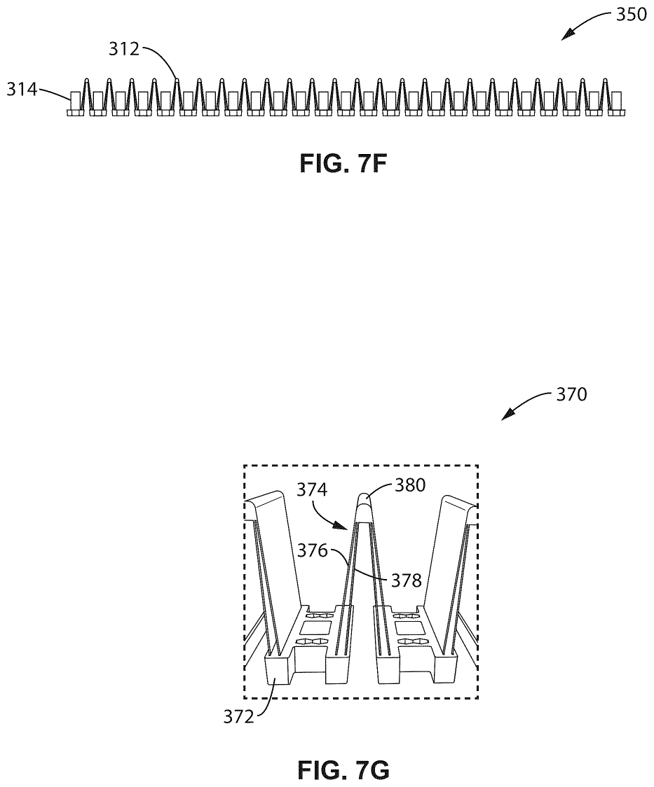

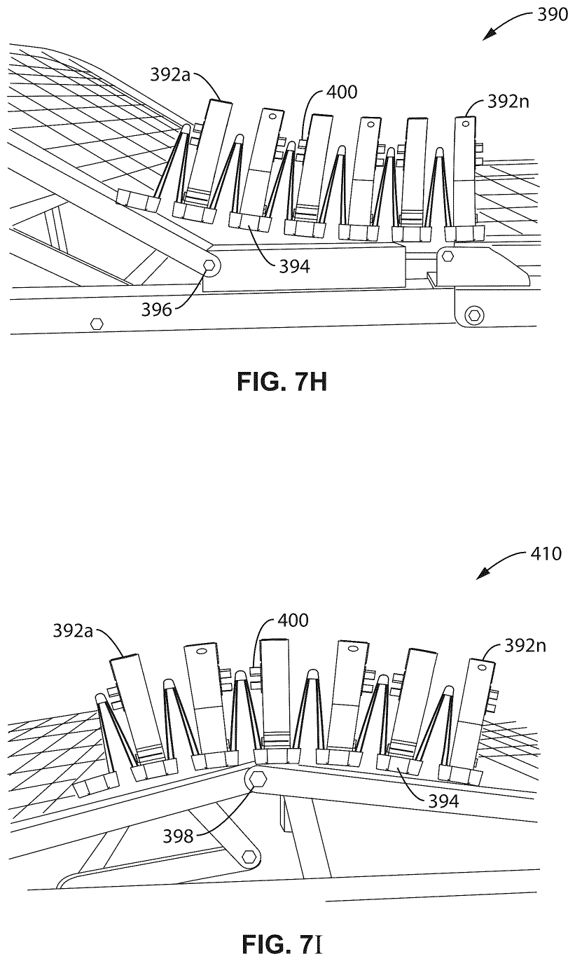

Optional compression spacer devices 75a, 75b are shown inserted onto the face of a mattress panel. These are described in greater detail in the description of FIG. 7H and FIG. 7I.

The top bars in the panels are configured for extending a limited amount along their length. The extensibility of these top bars enhance the kinematics of the panels in regard to the spacing (i.e., the pitch) and the height difference between the high and low-pressure regions (i.e., the amplitude) along the panel toward achieving a more uniform checkerboard pressure pattern. These top bars are configured for extending along their length when placed in tension, while remaining stiff in all other directions (including when the bars were compressed along their length). It should be appreciated by one of ordinary skill in the art that this one dimensional extensibility may be achieved in various ways without departing from the teachings of the present invention. The following provides a few examples given by way of example and not limitation.

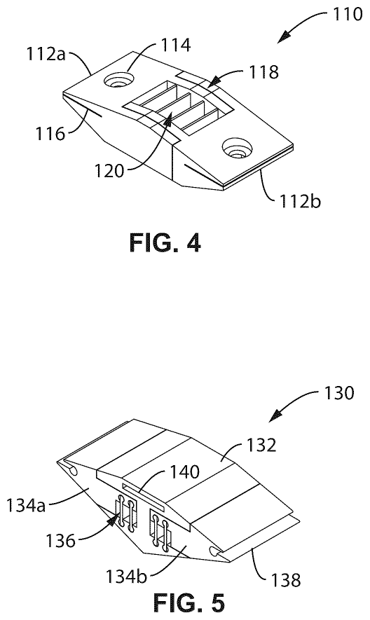

FIG. 4 illustrates an embodiment of a top bar 110, in which the two ends 112a 112b of the top bar have elements 118 which slidably engage one another, thus limiting travel in a single direction. A structure 120 interconnects to each of these slidably engaged elements and provides increasing tension as the two pieces extend. In the example this structure interconnecting the two sides is a single axis compliant element, which in this specific example is a rib like structure 120 that flexes. The top bar is shown with slots 116 on each for receiving the flexural hinge material, and a screw aperture 114 on each end, into which a screw is passed through the recessed aperture on the first side and through the flexural hinge material (e.g., a predetermined hole therein) and engages (e.g., threaded, or self-threading) the material on the opposing side.

FIG. 5 illustrates an example embodiment 130 having a main body 132 with recesses configured for slidably engaging ends 134a, 134b. Compliant elements 136 are seen for coupling ends 134a, 134b to the main body 132. The ends can extend from the main body, while moving in a single axis of travel, and limited by the extent of compliance of the compliant elements 136. The compliant elements 136 may comprise any desired material or structures which allow the ends to travel away from the main body until compliant elements 136 reach an end of travel. Compliant elements 136 may connect into, or pass through, one or both of the main body and end, toward securing these elements together.

Slots 138 are shown on each end, for receiving the flexural hinge material, such as a fold or seam therein being slid into an enlarged recess at the distal end of a slotted entry.

This top bar is shown configured with a linear aperture 140 through which a strap may be received that connects a plurality of top plates in a direction orthogonal to the orientation of the mattress panels.

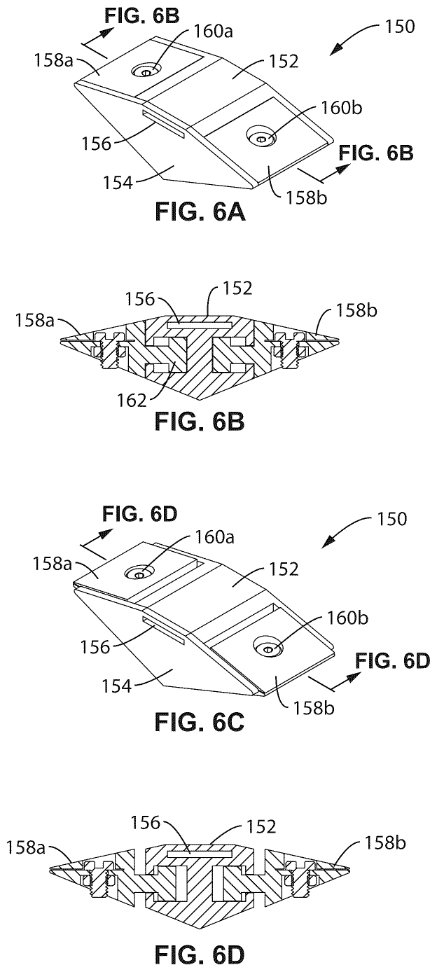

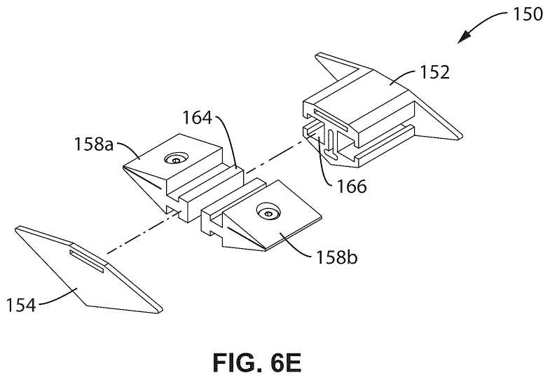

FIG. 6A through FIG. 6E illustrate an embodiment 150 of a top bar which utilizes sliding joints without flexures. In this top bar design the top bar has a main body 152 into which two ends 158a, 158b, are slidably engaged. The slidable engagement mechanism is configured for a limited range of extendibility, such that each end is retained in the main body between a minimum distance (contracted) and a maximum distance (extended). Furthermore, the slidable engagement is configured to limit movement other than extension. Thus, the ends of the top bar mechanism cannot be rotated or twisted. It should be appreciated that the following description provides one embodiment of forming this type of top bar, while other variations can be made without departing from the teachings of the present invention.

The top bar shown is symmetric and uses a purely rigid sliding prism joint 162, which is shown in its contracted and extended states (both isometric and cross section views) in FIG. 6A through FIG. 6D, while FIG. 6E depicts an exploded view of the top bar elements prior to assembly. It can be seen that the main body is formed with two portions 152, 154, thus allowing the insertion of the sliding prism joint from each end, prior to closing the main body with its second mating element. The sliding prism joint is shown being created with a cavity 166 in the main body and an opening into that cavity which is smaller. The end element of the top bar is formed with a protrusion having a thin bar element which substantially fits the opening into the cavity, and a wider portion 164 which substantially fits the interior of the cavity of the main body. Thus, when the protrusion is fit into the main body, and retained, the end portions are limited in their motion.

The flexural hinge members (shims) can be retained in the ends of these top bars in any desired manner, such as compression, slots, screws or any other mechanism that provides sufficient strength. In the example depicted, the hinge elements are retained by a fastener based compression, such as exemplified with a single screw 160a, 160b at each end. The main body preferably having material on either side of its sliding ends, so that the flexural hinge members (shims) are securely limited from shifting in any direction.

In addition, it will be seen that the main body is configured with a slot (or slots) through which a strap (or straps) may be passed when interconnecting the sequence of panels.

In at least one embodiment, straps are utilized for maintaining panel stability and for ensuring the panels move in synchronization with each other. The non-stretchable straps are configured to directly pass through the center slots 60, 68 of the top bars as shown in FIG. 3. It is important that those straps do not run along the high and low-pressure points, as then they would need to stretch to allow for the mechanical articulation of this mattress to function, and they are supposed to be able to resist tension by not stretching. Thus, it is important that the straps run along/through the centers of the top bars in each panel, so they twist and do not need to stretch during changing on from stable state to the other.

The purpose of these straps is (1) to help provide stability to the panels so they can better resist being sheared out of plane as users shift around on the mattress and (2) to help assure that all the panels move in the same direction, either to the left, or to the right as pressure points are alternated. Otherwise, if the separated panels were moved in different directions, the pressure profile would not be an alternating checkerboard pattern. It should be noted that the resulting checkerboard pattern changes depending on which direction the panels are moved. It should also be recognized that if an “alternating” checkerboard pattern is not clinically preferred, or for comfort reasons, not preferred over an “in-sync” checkerboard (where the peaks and troughs are not alternating along the length of the bed, but alternating only along the width), then the panels could be shifted to be aligned along the length of the bed so that all peaks appear in one lengthwise line and all troughs in the adjacent line.

### 3. Compliant Mattress Accessory Embodiments

This section details embodiments that can be classified into one of four different categories of accessories, which are designed to attach to and advance the capabilities of this mattress design. The four categories are described below.

### 3.1. Compliant Side-Flexure Attachments

FIG. 7A through FIG. 7I illustrate this compliant side-flexure attachment of the mattress panels, which facilitate use of this system in beds which can provide articulation. These side flexures enable the mattress to deform along its length, and to flex in the vertical direction to accommodate use on articulating bed frames.

In FIG. 7A is depicted an example of a conventional articulating bed frame 210. Compliant side-flexure attachments enable the mattress to deform along its length so that it can be used on a bed frame that raises and lowers the patient's head 212 and legs 214 as desired.

In FIG. 7B is illustrated an embodiment 250 with two rows of side flexure mechanisms 252a, 252b, shown for receiving mattress panels 254a through to 254n, over which is to be retained a cushioning material, such as a sheet of foam with ventilation holes.

In FIG. 7C and FIG. 7D is illustrated 270, 290, these side flexures 272 retaining a set of mattress panels 254 a through to 254n, over which is a mattress pad 256. The figures depict how the compliant side flexure mechanisms join the panel together and operate despite rotation occurring on the top surface 292, 294 of the mattress, as seen in FIG. 7D. The manner in which the side flexures retain the mattress panels allows the mattress to raise/lower the head or lower the legs, such as in the articulating bed frame seen in FIG. 7A, at any angle without shearing or pinching the skin while maintaining the alternating pressure in any state of the head raised/lowered. It should also be noted that the axis of rotation occurs parallel to the hinges of the bedframe, but located at the top surface of the mattress. Still further it should be noted that the side flexures and mattress panels are compliant along their length, whereby the side flexures and mattress panels do not need to be fabricated to fit a specific bed frame.

In FIGS. 7E and 7F is illustrated 310, 350, side flexures 312 into which the base portion of a number of mattress panels 314 are connecting into. In the figure, the side flexures are shown placed at either side near the ends of the panels, with the vertical extensions creating separation between consecutive panels.

In FIG. 7G is illustrated 370 a magnified view 370 of these side flexures having a flexure base 372, from which extend vertical flexing retention members 374. Each of these compliant side-flexures has a plurality of sections, with each section having a base for receiving a mattress panel and arms extending vertically and slightly outwardly, and which connect to the arms of adjacent sections. For purposes of this disclosure, the term “slightly outwardly” is intended to mean from about one degree to about thirty degrees in relation to vertical.

By way of example and not limitation, vertical flexing retention members 374 are shown fabricated from a thin flexible sheet metal, while per this example there is an outer 376 and inner 378 sheet element which connect to the base. The top of this flexure has elements 376 and 378 which may be nested to create a top surface, and/or a capping element may be used to connect the flexure elements or just to cover the nested flexure elements. It should be appreciated that other configurations which retain the panels while allowing flexibility to adjust to the directional perturbations of an articulating bedframe can be created without departing from the teachings of the present disclosure.

In FIG. 7H and FIG. 7I is illustrated 390, 410, a section of mattress panels 392a through 392n retained inside flexures 394, shown adjusting to a valley (recess) 396 in FIG. 7H and a hill (protrusion) 398 in FIG. 7I.

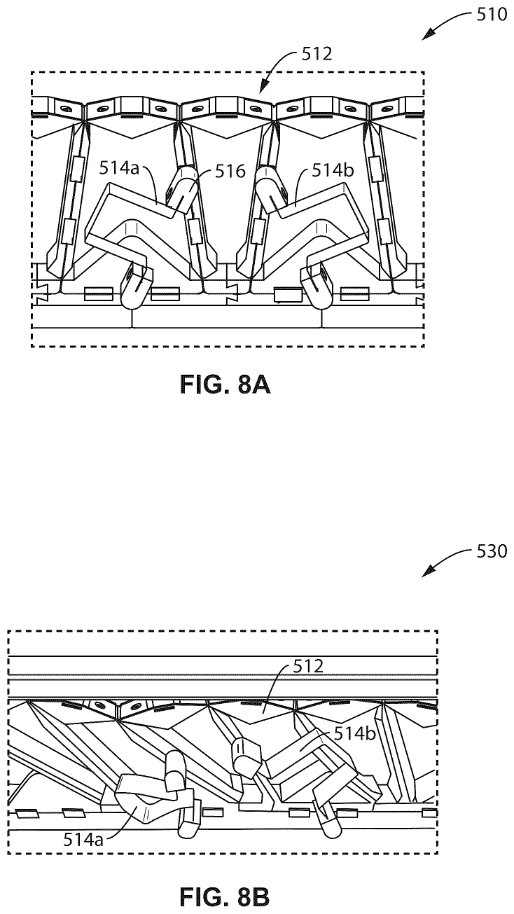

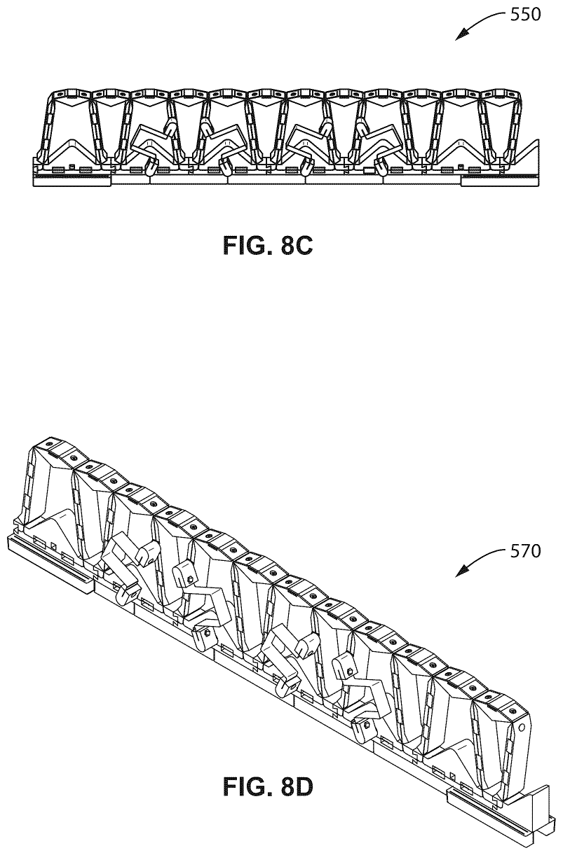

In addition, optional stubs 400 are shown to latch the static balancing springs shown in FIG. 8A through FIG. 10. In at least one embodiment, these stubs are formed to be coupled and/or inserted into the mattress panel, so that a portion extends to a desire length from the panel. In at least one embodiment the coupling of these structures to the mattress panel may be enhanced using a magnet, although other retention means or enhancement may be utilized, such as fasteners.

Accordingly, the use of the described side flexures enable the mattress to work on a bed frame that can have its head and leg portions raised or lowered. These side flexures enable the mattress to passively deform about any axis of rotation located along the top surface of the mattress while constraining the panels from moving in all other directions. In this way, the panels would not pinch or spread out along the patient's back as the bed frame is raised or lowered, which would keep the design's straps from needing to stretch or change length. The side flexures could have half-cylinder bases, or bases with rounded edges, to allow the mattress panels to slide along the bed's frame with minimal friction, or they could be made flat for greater stability. It should be noted that using these side flexures, the mattress can deform along the contour of the bed frame while still achieving an alternating checkerboard pressure profile as the panels are moved from left to right. The mattress is also more flexible with the side flexures than when it is attached to the rigid board. The mattress is also much easier to disassemble and package into a compact box for shipping purposes.

### 3.2. Static Balancing Mechanisms

In at least one embodiment, the mattress system can utilize static balancing springs that attach to the mattress panels to allow the mattress to be able to counter the weight of any patient so as to minimize the force required in alternating states of pressure, in switching panels from leaning left to leaning right and vice versa. Thus, the use of static balancing springs allow adjusting the mattress for occupants of differing weight while minimizing the force required in moving the tops the mattress from the first stable position to the second stable position, and from the second stable position to the first stable position.

These static balancing springs are configured for biasing the mattress panels to their center position, neither leaning to the right or to the left. It should be appreciated that any form of tensioning device may be utilized which attaches at two or more points between upper and lower portions of the mattress panel. In at least one embodiment the upper portion comprises an upper location along a rigid arm, while the lower portion comprises the base of the mattress panel.

FIG. 8A through FIG. 10 depict a few examples of static balancing embodiments. In one or more embodiments the static balancing springs can attach to the sides of the mattress panels to independently customize the mattress to the weight of any patient while still allowing the same mattress to achieve the same range of deformation regardless of patient weight.

In FIG. 8A through FIG. 8D is illustrated 510, 530, 550, 570, the static balancing springs fabricated as bent metal strips with ends configured for connection to the sides of the mattress panels. FIG. 8A depicts 510 a small segment of a mattress panel 512 which is retained in a centered orientation by two biasing springs 514a, 514b, Each biasing spring is preferably configured for opposing both tension and compression. By way of example and not limitation each balancing spring has attachment structures 516 at each end for connecting into the mattress panel, such as using the stubs 75a, 75b shown in FIG. 3, and a spring connecting between these two ends. Thus, each balancing spring has at least one spring portion which resists compression and/or tension, and has distal ends configured for making a swiveling connection to one or more locations on the side of each of said plurality of mattress panel. In the example shown in this figure, the spring portion is formed with one or more strips of flexible metal material. FIG. 8B depicts 530 the compression of one spring 514a, and the extension of the other spring 514b, when the upper surface of the mattress panel is leaning toward the left. FIG. 8C and FIG. 8D depict 550, 570, larger portions of a mattress panel using these static balancing springs.

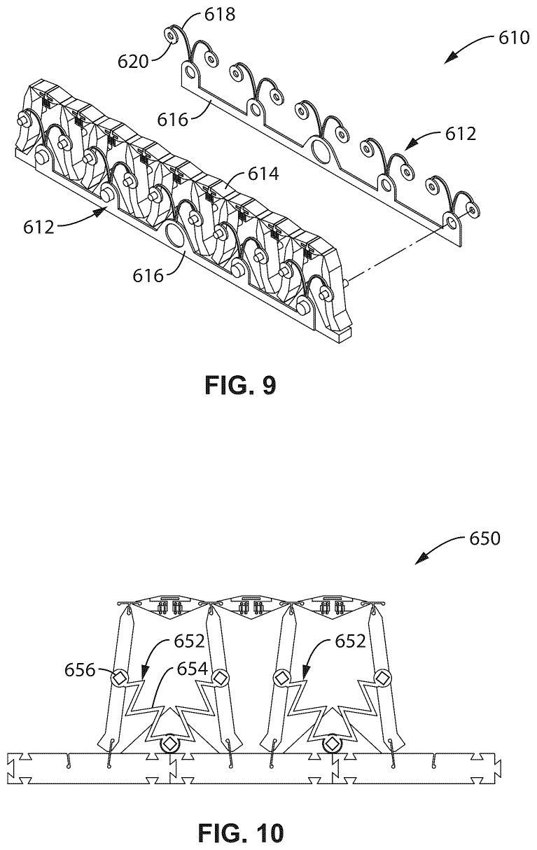

In FIG. 9 is illustrated static balancing springs 610 fabricated as thin monolithic plates that slide on one or both sides of the panels in different numbers that stack on top of each other to achieve custom static balancing capabilities. Each plate is shown with a base 616 that is configured for attachment to a side of the mattress panel, such as being slidably engaged thereupon, or otherwise attached. Extending from the base are one or multiple spring elements 618 which terminate in a coupling element 620 configured for attachment to an upper portion of the mattress panel, such as slidably engaged, or otherwise retained, for example on the stubs previous described.

In FIG. 10 is illustrated static balancing springs 650 that are fabricated as independent modules 652, which are configured with attachment points 656 to attach to locations on the mattress panel while providing springs between two or more of the attachment points. By way of example and not limitation, one such module is shown which is configured with an attachment point for the base, and two upper attachments points, with spring elements 654 between the bases an upper attachments points. In at least one embodiment these independent static balancing modules can slide on the panels as discrete stiffness elements adjacent to each other to tune the mattress stiffness. The springs here are exemplified as bent metallic structures in a zig-zag design, or they have the bent-blade design of the embodiments in of FIG. 8A through FIG. 8D, or may utilize other forms of springs.

It should be recognized that in any of the embodiments, insofar as the correct number of such static balancing springs are distributed correctly throughout the mattress, a person of any weight can be gently set down on the hard stops of the panels either to the left or to the right side. Moreover, it would require very little force to lift the patient from one side to the other (i.e., rock the mattress back and forth from one pressure profile to the next). Thus, static balancing springs not only provide a smooth transition from one stable state to the next, but they would also allow very small actuators to make the transition with a minimal application of force.

It should also be appreciated that variable tensioning mechanisms may be utilized in place of, or in combination with, the static balancing springs. These devices could allow the changing of spring biasing levels in response to a mechanical, electrical or even pneumatic input. For example, a linear actuator can be configured in a tubular housing within which a spring is also retained. The motion of the linear actuator compresses the spring essentially changing its spring constant, thus the pressure applied from the end of the linear actuator to the other end of the spring at the output changes in response to the electrical input to the actuator. Alternatively, a motor can be configured to drive a screw into/out of the tubular housing containing the spring to likewise change the spring constant. It will be appreciated that other forms of variable tension elements/devices can be utilized without departing from the teachings of the present disclosure. Although variable tensioning mechanisms are more complex, they do speed up the process of adjusting the bed for occupants of differing weights.

### 3.3. Positional Actuation Mechanisms

The mattress of the present disclosure has been shown in the preceding sections as configured for manually switching between its two active positions (trapezoids leaning right or left). However, in at least one embodiment the system is configured with an actuator attachment(s) for actively driving the mattress back and forth between its two alternating states of pressure (e.g., right and left), and preferably also providing a stable center position. Thus, a positional actuator can be used which connects to the mattress panel (internally or externally) to power the mattress panels between the center position, the first stable position, and the second stable position.

Actuating the mattress between alternating states can be performed in response to actuators which are driven electrically or pneumatically. The following describes one possible embodiment of such an actuator.

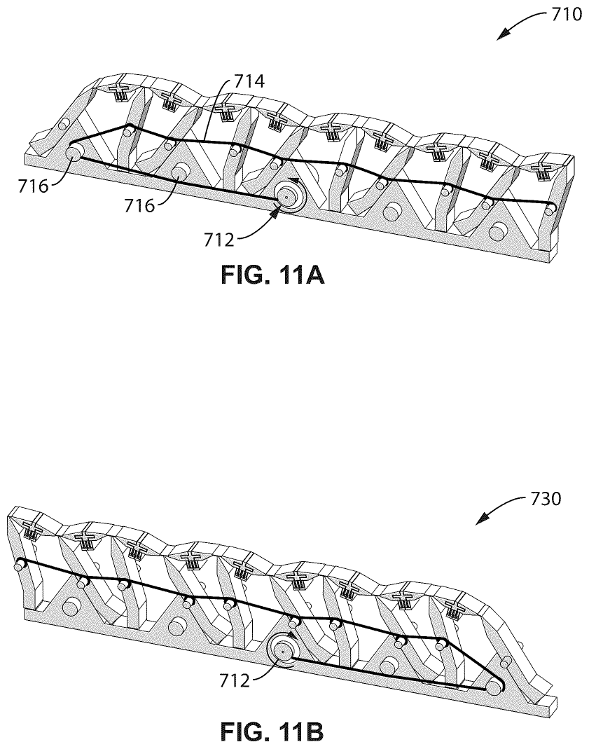

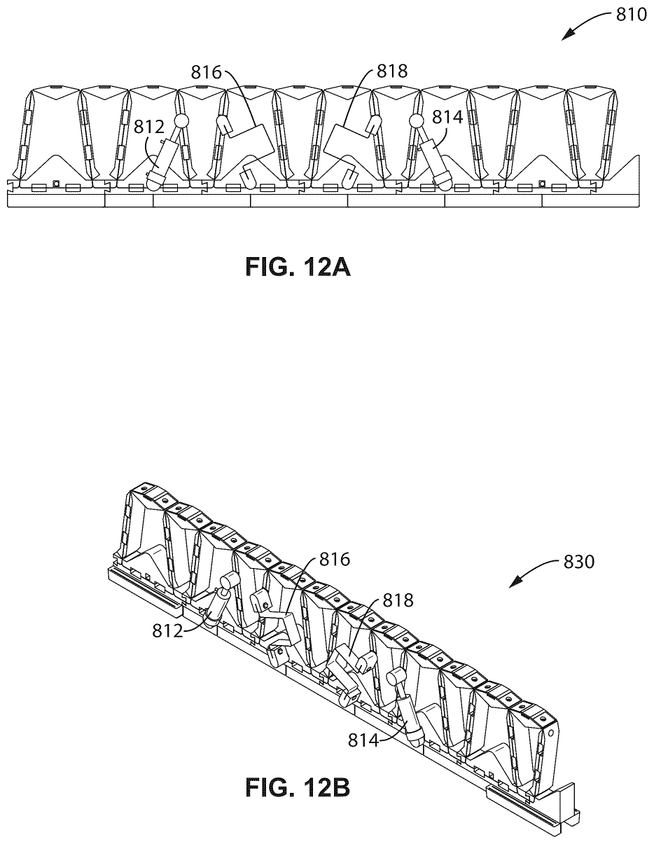

FIG. 11A and FIG. 11B depict an embodiment 710, 730 of an electrically driven actuator. One actuation concept integrates a few small motors within some of the panels, which are evenly spaced within the mattress. For the sake of simplicity of illustration, the figure depicts a drive pulley 712 to which a cable 714 is attached which is routed past redirection pulleys 716 and connects to selected vertical elements extending from the base. In FIG. 11A in response to a counterclockwise rotation of pulley 714, the cable will pull this mattress panel from its right leaning position, through its center position, and on to a left leaning position, while FIG. 12 depicts another mattress panel with an opposing routing of the cables, to pull this mattress panel from a left leaning position, through its center position to a right leaning position. The pulley is connected to an electrical motor which can drive the pulley to retract the cable and thus change the pressure state of the mattress. By having mattress panels with alternating cabling as in FIG. 11A and FIG. 11B, the top of the mattress can be switched between its two states. As long as multiple evenly spaced motors pull in sync in the same direction, the mattress can be actuated back and forth as desired. It should be appreciated that the actuation hardware (e.g., motor, cable and pulleys) need not be used on every mattress panel, as the straps passing through the top bars will convey the motive force between one panel and another.

It should be appreciated that the cabling may also be routed in a complete loop with each end terminating on a different pulley on the same shaft. Rotating the pulley in the first direction moves the panel top to the right and a second direction moving it to the left, thus requiring fewer motors.

It will also be noted that embodiments can operate with pulleys ganged onto a shaft of a motor which connects to multiple of such pulleys.

Simple sensors, or limit switches, could also be connected to discern when sufficient travel has been achieved, whereby motors are deactivated in that direction.

FIG. 12A and FIG. 12B illustrate an embodiment 810, 830, of another actuation mechanism that integrates a few small actuators within some of the mattress panels. This design uses linear actuators instead of rotatory motors with cables.

The linear actuators can be deployed in pairs, such as seen by actuators 812, 814, especially if actuators are utilized which exert higher driving power in one direction than the other. At the two points where the linear actuator ends attach to the base of the panels and to their struts, the linear actuators can freely rotate. Thus, when the actuators extend or contract, the linear actuators can drive the mattress panels back-and-forth.

Another benefit is that these actuators can slide onto the same mountings 400 (e.g., stubs) onto which the static balancing springs are configured to attach. A combination of linear actuators 812, 814, and static balancing springs 816, 818 may be utilized, as shown in the figure. Thus, insofar as there are sufficient linear actuators utilized and evenly distributed within the mattress, the mattress can be actuated. Successful actuation should be achievable without using an inordinate number of the static balance spring mounting locations, allowing the use of plenty of static balancing springs to customize the mattress to the weight of its users to reduce the need for high-powered actuators.

Other actuation mechanisms may be utilized, other than that described above. One type is the use of independent mechanisms (i.e., standalone products) to actuate the passive mattress concept, without the necessity of being integrated into the mattress of the present disclosure.

For example, in at least one embodiment, such an actuator can be configured to attach to the portion of the bed frame that does not raise and lower and incorporates actuators that drive moving parts to push the mattress panels to the left or to the right. They can also lock the mattress in any configuration between the two extreme states of alternating pressure, and thus help stabilize the bed, for instance, when users are climbing into it or getting out of it. They can also reduce mattress amplitude by not lowering its panels to their hard stops if smaller amplitudes are sufficient to prevent bed sores for some patients. The following presents two such independent actuation mechanisms.

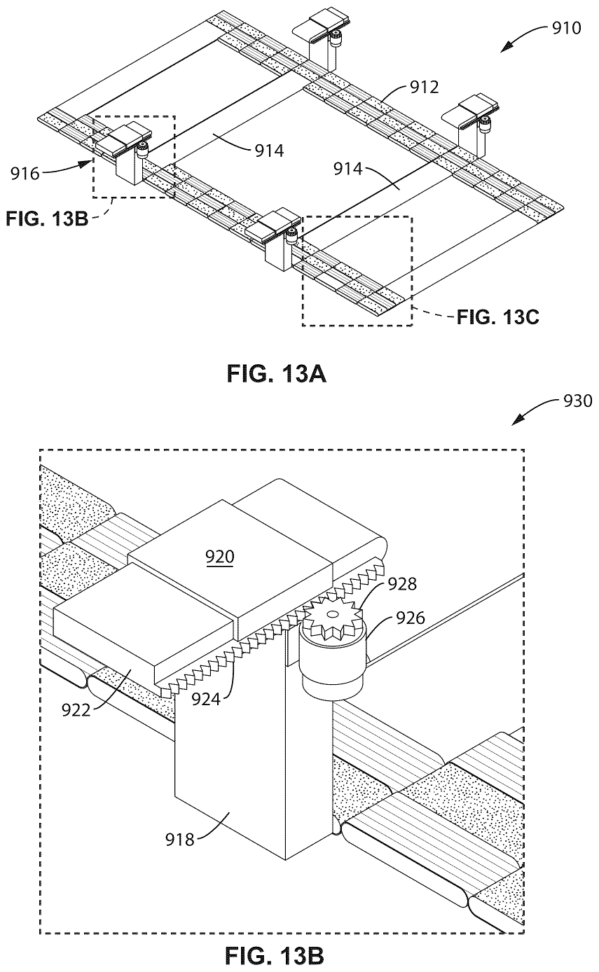

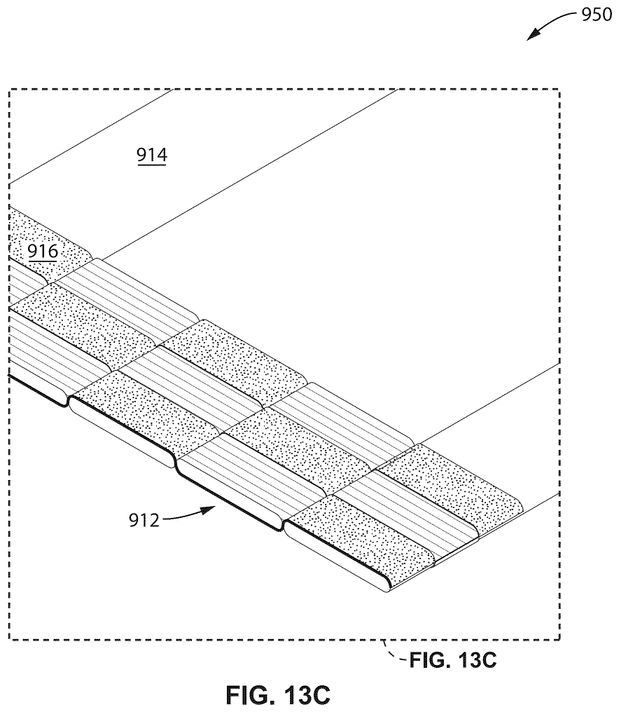

FIG. 13A through FIG. 13C illustrates an embodiment 910, 930, 950 in which the actuators are contained on each side of the bed. A bed support 912 is shown which is retained over an articulating bed frame as was seen in FIG. 7A. FIG. 13C depicts this support having a plurality of thin wooden slats 914 that are woven together using multiple (e.g., three) ribbons on each side, thereby retaining the panels in close proximity, while allowing the structure to flex across the width of the bed to follow the contour of the bed surface for the articulating bed. Since the wooden slats have rounded ends, they are allowed to roll along each other (guided by the ribbons) to conform to the shape of any bed frame. The mattress of the present disclosure would then be set on top of the wooden slats.

In the figure there are two vertical support structures 918 on each side of the bed, each of which is configured with a linear retention housing 920 for retaining linear actuating plate 922, which is coupled for being driven by an electrical actuator or motor. By way of example, and not limitation, the linear actuating plate is shown with gear teeth 924 for engaging teeth 928 of a rotary actuator 926. Thus, the motors rotate gears (i.e., pinions) that drive a rack to push the mattress panels back and forth. Although the gear teeth are shown here for the sake of illustration, it is preferable that any such gearing would be on an interior recess of the linear actuating plate with the motor preferably retained in support 918. The actuators on either side of the bed are configured to work in tandem, such that as actuators on the right side of the mattress advance, the actuators on the left side would retract; thus, allowing driving the mattress mechanism back-and-forth between its two alternating pressure configurations.

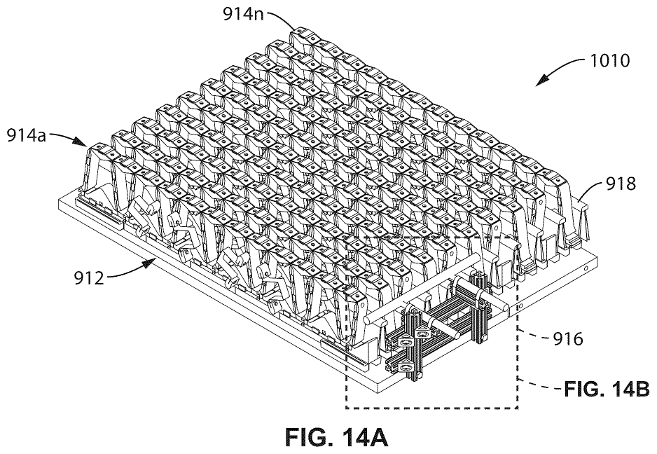

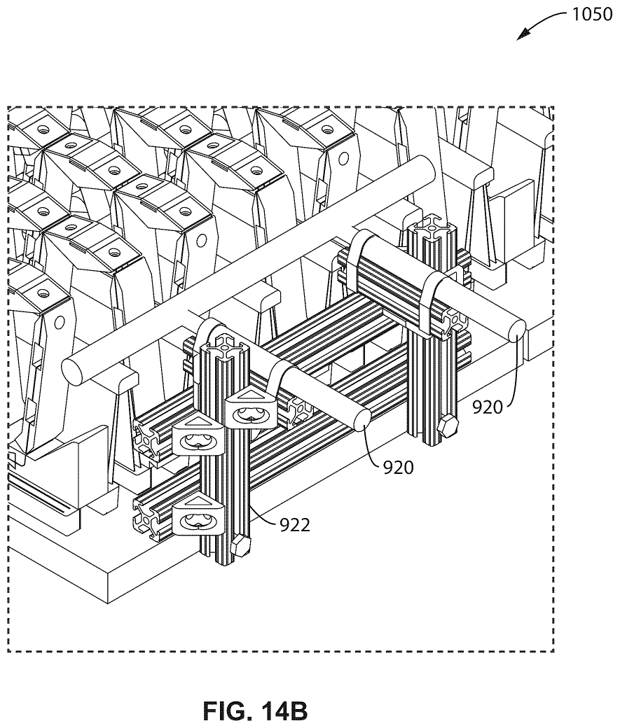

FIG. 14A and FIG. 14B illustrate an embodiment 1010 of another linear actuator configuration that can be attached 916 to the slats that drive the panels back and forth. In this example, the vertical structure 922 extends from bed support 912 and retains two cylindrical receiver tubes 920, into which rods extending from a push bar 918, are slidably engaged. An actuator can be connected to drive push bar 918. Preferably, the receiver tubes themselves may comprise linear actuators from which rods extend to connect to push bar 918.

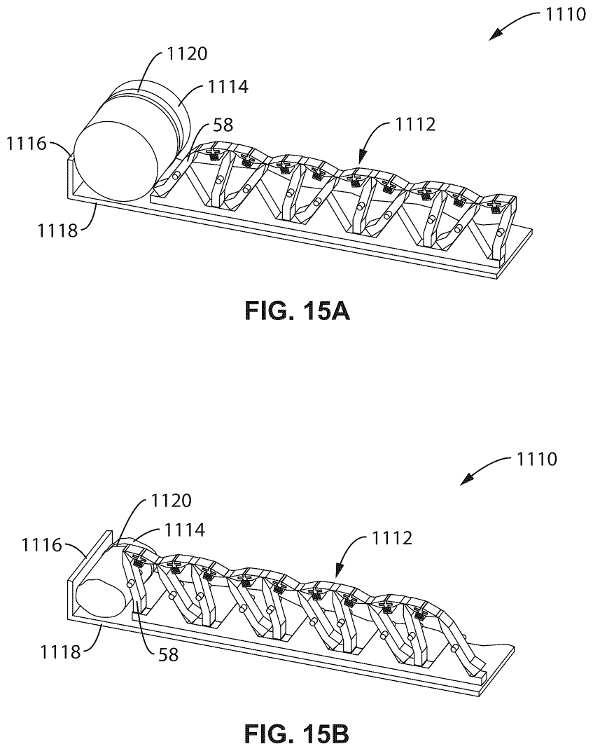

FIG. 15A and FIG. 15B illustrate an embodiment 1110 of another form of actuator which utilize an airtight flexible tube (e.g., rubber bladder) 1112 at approximate height of the mattress panels, on each side spanning the full length. One side of a mechanism panel 1112 is shown in the figures with the edge vertical element 58 as was seen in FIG. 3. For illustrative purposes, only a portion of a single mattress panel, without the flexure support, is shown directly over a small portion of the bed support, and only a small section of the airtight flexible tube is seen in the figure.

This flexible tube 1114 passes along both sides of the mattress panels (or a desired portion thereof). One end of the tube is closed off and the other end connected to a segment of tubing. The ends for example may terminate in cup-like structures, one being closed, the other having a fitting for connecting up to a section of tubing. The termination of the flexible tubes, the tubing, valves and motors are not shown in this figure for simplicity of illustration. The tubing extending from each side connects through an electrical valve to individual air pumps, or through an electrically controlled T-valve to a single air pump. A narrow lip 1116 and underlying strip 1118 extend to the edge of the bed frame, such as being a modification of bed support 912. In addition lip 1116 may alternatively comprise a semi-circular section surrounding a portion of the tube 1114, and could be made of a plastic, or dense foam, to simplify entry/exit from the bed.

In operation these bladders can be expanded with air, or the air released to any desired extent. To create a stable platform, both bladders can be partially filled; while moving the mattress panel from one stable state to the other involves inflating one side fully and fully releasing the air from the other side. In FIG. 15A tube 1114 is shown fully inflated which directs the mattress panel segments to the right, presuming in this figure that the left side tube is being deflated. In FIG. 15B tube 1114 is shown partially deflated which allows the pressure being applied from the full pressure tube on the right side to shift the mattress panel segments to the left. If the ‘throw’ required is less than the height, then two tubes can be connected in vertical-tandem in each side, thus matching mattress height while providing the desired level of displacement (throw).

This air driven mechanism may have certain advantages in regard to simplicity and shape factor. This approach can also apply pressure across the whole side of the mattress without interfering with ingress or egress. These tube(s) can also be collared down 1120 to the bed support, including at the locations where the bed frame articulates, and it will still inflate and de-inflate to operate the mechanism. In addition, this approach does not need to extend past that of the bed frame, as shown in the figure, as it can be contained on the edges of the bed support, and would provide a soft and smooth entry/exit on the sides of the mattress.

### 4. Summary of Selected Implementation Features

From the description herein, it will be appreciated that the present disclosure encompasses multiple implementations of the technology which include, but are not limited to, the following.
A. Straps for maintaining panel stability and for ensuring the panels move in sync with each other.
B. Metal shim inserts to achieve compliant panel hinges.
C. An extendable top bar in each panel to allow the pitch and amplitude of the mattress to remain regular across the panels.
D. Compliant side-flexure attachments that enable the mattress to deform along its length so that it can be utilized on an articulating bed frame, such as one that raises and lowers the patient's head and legs as desired. These compliant side flexure Mechanisms join the panel through rotational joints having an axis of rotation at the top surface of the mattress. This allows the mattress to raise/lower the head or lower the legs at any angle without shearing or pinching the skin minimally while the maintaining the alternating pressure as unaffected as possible in any state of the head raised/lowered. Also, the axis of rotation is parallel to the hinges of the bedframe but located at the top surface of the mattress.
E. Static balancing springs that attach to the panels to allow the mattress to be able to counterbalance the weight of any patient to minimize the force required in switch the mattress between its two states of pressure.
F. Actuator attachments for actively driving the mattress back and forth between its two alternating states of pressure.
G. One or more of the foregoing implementations incorporated into a mattress apparatus wherein the mattress apparatus comprises: (a) a foam pad with holes in it (to allow for ventilation) placed on top of alternating compliant panels that are stabilized by a grid of straps on top and are attached to a rigid board on the bottom; or (b) a foam pad with a top surface and a bottom surface; a webbing layer mounted to the bottom surface of the foam pad; a dynamic layer of a plurality of planar panels with a deformable strip coupled to the webbing layer, a base and two or more legs coupled to the deformable strip and base with resilient hinges; and a foundation layer coupled to the base of the panels; wherein the legs and deformable strip of the dynamic layer can move between two stable positions; and wherein movement of the legs and deformable strip in relation to the base of each panel causes deformations in the deformable strip; or (c) a support substrate; a plurality of planar panels having an upper member coupled to a base member with a plurality of legs and flexible hinges, said base member mounted to said support substrate, said panels oriented parallel to each other; a grid of straps joined to said upper member of said panels; and a top layer coupled to said grid of straps; wherein each upper member of said panels moves in relation to the base member from a first stable position to a second stable position; or (d) a top layer comprising a foam pad with periodically positioned holes through the pad, the holes configured for air circulation through the top layer; a grid of straps beneath the top layer the straps configured for air circulation through the top layer; a plurality of horizontal compliant panels beneath the grid of straps, the grid of straps providing support for the panels, the plurality of panels forming a compliant web; and a support substrate beneath the panels; wherein the compliant web is configured to move between first and second stable positions in response to application of horizontal force.
H. An improved mattress apparatus for preventing bed sores, comprising any of the preceding implementations.

### 5. General Scope of Embodiments

An improved mattress apparatus for preventing bed sores, comprising of balancing springs that counteract the patients' weight of any patient so that it takes little energy to switch alternating states of pressure.

An improved mattress apparatus for preventing bed sores, comprising of actuator attachments for actively driving the mattress back and forth between its two alternating states of pressure.

An improved mattress apparatus for preventing bed sores, comprising of extendable top bar in each panel to allow the pitch and amplitude of the mattress to remain regular across the panels.

An improved mattress apparatus for preventing bed sores, comprising: (a) compliant side-flexure attachments that enable the mattress to deform along its length so that it can be used on a bed frame that raises and lowers the patient's head and legs as desired; (b) wherein these compliant side flexure Mechanisms join the panel through rotational joints with the axis of rotation on the top surface of the mattress, toward allowing the mattress to raise/lower the head or lower the legs at any angle without shearing or pinching the skin minimally while maintaining the alternating pressure as unaffected as possible in any state of the head raised or lowered; wherein the axis of rotation is parallel to the hinges of the bedframe but located at the top surface of the mattress.

A mattress apparatus for preventing bed sores, the apparatus comprising: (a) a plurality of mattress panels which are retained in parallel and of a length to span the desired area of the mattress; (b) wherein each mattress panel comprises unit cells in which a plurality of hinged rigid legs connect between a base to a top bar; (c) wherein said top bar of each mattress panel can deform from a center position to a first and second stable position on either side along the axis of the mattress panel; (d) a plurality of straps which connect through the top bars of each mattress panel to top bars in other mattress panels within the mattress; and (e) wherein when said top bars of said plurality of mattress panels are shifted to the first stable position, the topside of the top bars form a first checkerboard pattern of hills and valleys, and when the top bars of said mattress panels are shifted to the second stable position, they form a complementary second checkerboard pattern of hills and valleys in which the hills are now valleys, and the valleys are now hills, thus changing the pressure pattern applied to the occupant lying on the mattress to overcome the issue with bed sores.

In a mattress apparatus for preventing bed sores, wherein the apparatus comprises: (a) a foam pad with holes in it (to allow for ventilation) placed on top of alternating compliant panels that are stabilized by a grid of straps on top and are attached to a rigid board on the bottom; or (b) a foam pad with a top surface and a bottom surface; a webbing layer mounted to the bottom surface of the foam pad; a dynamic layer of a plurality of planar panels with a deformable strip coupled to the webbing layer, a base and two or more legs coupled to the deformable strip and base with resilient hinges; and a foundation layer coupled to the base of the panels; wherein the legs and deformable strip of the dynamic layer can move between two stable positions; and wherein movement of the legs and deformable strip in relation to the base of each panel causes deformations in the deformable strip; or (c) a support substrate; a plurality of planar panels having an upper member coupled to a base member with a plurality of legs and flexible hinges, said base member mounted to said support substrate, said panels oriented parallel to each other; a grid of straps joined to said upper member of said panels; and a top layer coupled to said grid of straps; wherein each upper member of said panels moves in relation to the base member from a first stable position to a second stable position; or (d) a top layer comprising a foam pad with periodically positioned holes through the pad, the holes configured for air circulation through the top layer; a grid of straps beneath the top layer the straps configured for air circulation through the top layer; a plurality of horizontal compliant panels beneath the grid of straps, the grid of straps providing support for the panels, the plurality of panels forming a compliant web; and (e) a support substrate beneath the panels; wherein the compliant web is configured to move between first and second stable positions in response to application of horizontal force; (f) the improvement comprising one or more of the following: (i) straps for maintaining panel stability and for ensuring the panels move in sync with each other; (ii) metal shim inserts to achieve compliant panel hinges; (iii) extendable top bar in each panel to allow the pitch and amplitude of the mattress to remain regular across the panels; and (iv) embedded pressure sensors to monitor the patient without the use of a sensor mat; (v) compliant side-flexure attachments that enable the mattress to deform along its length so that it can be used on a bed frame that raises and lowers the patient's head and legs as desired; (vi) static balancing springs that attach to the panels to allow the mattress to be able to counter the weight of any patient so that it takes little energy to switch alternating states of pressure; (vii) actuator attachments for actively driving the mattress back and forth between its two alternating states of pressure; and (viii) a complementary foam pad that improves comfort and envelopment while passing the regions of high pressure through to the patient's back, so its ability to eliminate bed sores is not compromised.

The apparatus of any preceding implementation, wherein each said top bar is configured for expanding and contracting along its length toward allowing the hinged rigid legs to move over larger deformation ranges.

The apparatus of any preceding implementation, wherein said hinged rigid legs connect between a base to a top bar, with a hinge in which hinge material is connected into the top bar and passes through a first rigid leg and into the base, and then passes up through an adjacent rigid leg and connects to the opposite side of the same top bar.

The apparatus of any preceding implementation, wherein said hinge material comprises a flexible metal strip.

The apparatus of any preceding implementation, each unit cell, with its plurality of hinged rigid legs connecting between a base to a top bar, are formed into two adjacent trapezoids which share their outer rigid legs with bordering unit cells.

The apparatus of any preceding implementation, further comprising a stop retained on the base of each unit cell of each said mattress panel between neighboring hinged rigid legs of said plurality of hinged rigid legs, with each stop across the plurality of unit cells limit the extent of deformation from the center position to the first and the second stable position.

The apparatus of any preceding implementation, further comprising multiple compliant side-flexures for retaining said plurality of mattress panels in parallel.

The apparatus of any preceding implementation, wherein each said compliant side-flexure comprises a plurality of sections, with each section having a base for receiving a mattress panel and arms extending vertically and slightly outwardly, and which connect to the arms of adjacent sections.

The apparatus of any preceding implementation, wherein said compliant side-flexures enable the mattress to deform along its length, and to flex in the vertical direction to accommodate use on articulating bed frames.

The apparatus of any preceding implementation, wherein each of said arms which extend vertically and slightly outwardly comprise a pair of flexible metallic members.

The apparatus of any preceding implementation, further comprising static balancing springs that attach to the mattress panels for adjusting the mattress for occupants of differing weight while minimizing the force required in moving the tops the mattress from the first stable position to the second stable position, and from the second stable position to the first stable position.

The apparatus of any preceding implementation, wherein each said balancing spring is configured for attachment between an upper and a lower section on the side of a mattress panel.

The apparatus of any preceding implementation, wherein said upper and lower section on the side of the mattress panel comprise an upper section comprises an upper location along a rigid arm, while the lower section comprises the base of the mattress panel.

The apparatus of any preceding implementation, wherein each balancing spring has at least one spring portion which resists compression and/or tension, and has distal ends configured for making a swiveling connection to one or more locations on the side of each of said plurality of mattress panel.

The apparatus of any preceding implementation, further comprising a positional actuator which connects to the mattress panel to power the mattress panels between the center position, the first stable position, and the second stable position.

The apparatus of any preceding implementation, wherein said positional actuator can be driven electrically or pneumatically.

The apparatus of any preceding implementation, wherein said positional actuators comprise a plurality of linear actuators connecting between the base and upper portions of selected rigid arms within each mattress panel.

The apparatus of any preceding implementation, wherein said positional actuators comprise a rotational actuator connected to a pulley, or pulleys, which operate through a cable to pull upper portions of selected rigid arms toward the first or second stable state.

The apparatus of any preceding implementation, wherein said positional actuators comprise a rotational actuator connected to gearing to push the mattress panels within the mattress from one stable state to the other, or to retain the mattress in a center state.

The apparatus of any preceding implementation, wherein said positional actuators comprise linear actuators connected to a push bar toward moving the mattress from one stable state to the other, or to retain the mattress in a center state.

The apparatus of any preceding implementation, wherein said positional actuators comprise elongate pneumatic structures, with one pneumatic structure on either side of the mattress, with each said pneumatic structure being filled with air to expand the elongate pneumatic structure, or air released to contract the elongate pneumatic structure, in response to which the mattress panels are moved within the mattress from one stable state to the other, or to retain the mattress in a center state.

As used herein, the term “implementation” is intended to include, without limitation, embodiments, examples, or other forms of practicing the technology described herein.

As used herein, the singular terms “a,” “an,” and “the” may include plural referents unless the context clearly dictates otherwise. Reference to an object in the singular is not intended to mean “one and only one” unless explicitly so stated, but rather “one or more.”

Phrasing constructs, such as “A, B and/or C”, within the present disclosure describe where either A, B, or C can be present, or any combination of items A, B and C. Phrasing constructs indicating, such as “at least one of” followed by listing a group of elements, indicates that at least one of these groups of elements is present, which includes any possible combination of the listed elements as applicable.

References in this disclosure referring to “an embodiment”, “at least one embodiment” or similar embodiment wording indicates that a particular feature, structure, or characteristic described in connection with a described embodiment is included in at least one embodiment of the present disclosure. Thus, these various embodiment phrases are not necessarily all referring to the same embodiment, or to a specific embodiment which differs from all the other embodiments being described. The embodiment phrasing should be construed to mean that the particular features, structures, or characteristics of a given embodiment may be combined in any suitable manner in one or more embodiments of the disclosed apparatus, system, or method.

As used herein, the term “set” refers to a collection of one or more objects. Thus, for example, a set of objects can include a single object or multiple objects.

Relational terms such as first and second, top and bottom, upper and lower, left and right, and the like, may be used solely to distinguish one entity or action from another entity or action without necessarily requiring or implying any actual such relationship or order between such entities or actions.

The terms “comprises,” “comprising,” “has”, “having,” “includes”, “including,” “contains”, “containing” or any other variation thereof, are intended to cover a non-exclusive inclusion, such that a process, method, article, apparatus, or system, that comprises, has, includes, or contains a list of elements does not include only those elements but may include other elements not expressly listed or inherent to such process, method, article, apparatus, or system. An element proceeded by “comprises . . . a”, “has . . . a”, “includes . . . a”, “contains . . . a” does not, without more constraints, preclude the existence of additional identical elements in the process, method, article, apparatus, or system, that comprises, has, includes, contains the element.

As used herein, the terms “approximately”, “approximate”, “substantially”, “substantial”, “essentially”, and “about”, or any other version thereof, are used to describe and account for small variations. When used in conjunction with an event or circumstance, the terms can refer to instances in which the event or circumstance occurs precisely as well as instances in which the event or circumstance occurs to a close approximation. When used in conjunction with a numerical value, the terms can refer to a range of variation of less than or equal to ±10% of that numerical value, such as less than or equal to ±5%, less than or equal to ±4%, less than or equal to ±3%, less than or equal to ±2%, less than or equal to ±1 %, less than or equal to ±0.5%, less than or equal to ±0.1 %, or less than or equal to ±0.05%. For example, “substantially” aligned can refer to a range of angular variation of less than or equal to ±10°, such as less than or equal to ±5°, less than or equal to ±4°, less than or equal to ±3°, less than or equal to ±2°, less than or equal to ±1°, less than or equal to ±0.5°, less than or equal to ±0.1°, or less than or equal to ±0.05°.

Additionally, amounts, ratios, and other numerical values may sometimes be presented herein in a range format. It is to be understood that such range format is used for convenience and brevity and should be understood flexibly to include numerical values explicitly specified as limits of a range, but also to include all individual numerical values or sub-ranges encompassed within that range as if each numerical value and sub-range is explicitly specified. For example, a ratio in the range of about 1 to about 200 should be understood to include the explicitly recited limits of about 1 and about 200, but also to include individual ratios such as about 2, about 3, and about 4, and sub-ranges such as about 10 to about 50, about 20 to about 100, and so forth.

The term “coupled” as used herein is defined as connected, although not necessarily directly and not necessarily mechanically. A device or structure that is “configured” in a certain way is configured in at least that way, but may also be configured in ways that are not listed.

Benefits, advantages, solutions to problems, and any element(s) that may cause any benefit, advantage, or solution to occur or become more pronounced are not to be construed as a critical, required, or essential feature or element of the technology described herein or any or all the claims.

In addition, in the foregoing disclosure various features may be grouped together in various embodiments for the purpose of streamlining the disclosure. This method of disclosure is not to be interpreted as reflecting an intention that the claimed embodiments require more features than are expressly recited in each claim. Inventive subject matter can lie in less than all features of a single disclosed embodiment.

The abstract of the disclosure is provided to allow the reader to quickly ascertain the nature of the technical disclosure. It is submitted with the understanding that it will not be used to interpret or limit the scope or meaning of the claims.

It will be appreciated that the practice of some jurisdictions may require deletion of one or more portions of the disclosure after the application is filed. Accordingly, the reader should consult the application as filed for the original content of the disclosure. Any deletion of content of the disclosure should not be construed as a disclaimer, forfeiture, or dedication to the public of any subject matter of the application as originally filed.

All text in a drawing figure is hereby incorporated into the disclosure and is to be treated as part of the written description of the drawing figure.

The following claims are hereby incorporated into the disclosure, with each claim standing on its own as a separately claimed subject matter.

Although the description herein contains many details, these should not be construed as limiting the scope of the disclosure, but as merely providing illustrations of some of the presently preferred embodiments. Therefore, it will be appreciated that the scope of the disclosure fully encompasses other embodiments which may become obvious to those skilled in the art.

All structural and functional equivalents to the elements of the disclosed embodiments that are known to those of ordinary skill in the art are expressly incorporated herein by reference and are intended to be encompassed by the present claims. Furthermore, no element, component, or method step in the present disclosure is intended to be dedicated to the public regardless of whether the element, component, or method step is explicitly recited in the claims. No claim element herein is to be construed as a “means plus function” element unless the element is expressly recited using the phrase “means for”. No claim element herein is to be construed as a “step plus function” element unless the element is expressly recited using the phrase “step for”.

What is claimed is:

1. A mattress apparatus for preventing bed sores, the apparatus comprising:
(a) a plurality of mattress panels which are retained in parallel and of a length to span a desired area of the mattress;
(b) wherein each mattress panel comprises unit cells in which a plurality of hinged rigid legs connect between a base to a top bar;
(c) wherein said top bar of each mattress panel can move, upon deforming the hinged rigid legs, from a center position to a first and second stable position on either side along the axis of the mattress panel;
(d) a plurality of straps which connect through the top bars of each mattress panel to top bars in other mattress panels within the mattress; and
(e) wherein when said top bars of said plurality of mattress panels are shifted to the first stable position, the topside of the top bars form a first checkerboard pattern of hills and valleys, and when the top bars of said mattress panels are shifted to the second stable position, they form a complementary second checkerboard pattern of hills and valleys in which the hills are now valleys, and the valleys are now hills, thus changing a pressure pattern applied to an occupant lying on the mattress to overcome an issue with bed sores.

2. The apparatus of claim 1, wherein each said top bar is configured for expanding and contracting along its length to allow the hinged rigid legs to move over larger deformation ranges.

3. The apparatus of claim 1, wherein said hinged rigid legs connect between the base and the top bar, with a hinge in which hinge material is connected into the top bar and passes through a first rigid leg and into the base, and then passes up through an adjacent rigid leg and connects to the opposite side of the same top bar.

4. The apparatus of claim 3, wherein said hinge material comprises a flexible metal strip.

5. The apparatus of claim 4, wherein each unit cell, with its plurality of hinged rigid legs connecting between the base and the top bar, are formed into two adjacent trapezoids which share their outer rigid legs with bordering unit cells.

6. The apparatus of claim 1, further comprising a stop retained on the base of each unit cell of each said mattress panel between neighboring hinged rigid legs of said plurality of hinged rigid legs, with each stop across the plurality of unit cells limit the extent of deformation from the center position to the first and the second stable position.

7. The apparatus of claim 1, further comprising multiple compliant side-flexures for retaining said plurality of mattress panels in parallel.

8. The apparatus of claim 7, wherein each said compliant side-flexure comprises a plurality of sections, with each section having a base for receiving a mattress panel and arms extending vertically and slightly outwardly, and which connect to the arms of adjacent sections.

9. The apparatus of claim 8, wherein said compliant side-flexures enable the mattress to deform along its length, and to flex in the vertical direction to accommodate use on articulating bed frames.

10. The apparatus of claim 8, wherein each of said arms which extend vertically and slightly outwardly comprise a pair of flexible metallic members.

11. The apparatus of claim 1, further comprising static balancing springs that attach to the mattress panels for adjusting the mattress for occupants of differing weight while minimizing the force required in moving the top bars of each mattress panel from the first stable position to the second stable position, and from the second stable position to the first stable position.

12. The apparatus of claim 11, wherein each said balancing spring is configured for attachment between an upper and a lower section on the side of a mattress panel.

13. The apparatus of claim 12, wherein said upper and lower section on the side of the mattress panel comprise an upper section which comprises an upper location along a rigid arm, while the lower section comprises the base of the mattress panel.

14. The apparatus of claim 12, wherein each balancing spring has at least one spring portion which resists compression and/or tension, and has distal ends configured for making a swiveling connection to one or more locations on the side of each of said plurality of mattress panels.

15. The apparatus of claim 1, further comprising a positional actuator which connects to the mattress panel to power the mattress panels between the center position, the first stable position, and the second stable position.

16. The apparatus of claim 15, wherein said positional actuator can be driven electrically or pneumatically.

17. The apparatus of claim 15, wherein said positional actuator comprises a plurality of linear actuators connecting between the base and upper portions of selected rigid arms within each mattress panel.

18. The apparatus of claim 15, wherein said positional actuator comprises a rotational actuator connected to a pulley, or pulleys, which operate through a cable to pull upper portions of selected rigid arms toward the first or second stable position.

19. The apparatus of claim 15, wherein said positional actuator comprises a rotational actuator connected to gearing to push the mattress panels within the mattress from one stable position to the other, or to retain the mattress in a center position.

20. The apparatus of claim 15, wherein said positional actuator comprises linear actuators connected to a push bar toward moving the mattress from one stable position to the other, or to retain the mattress in a center position.

21. The apparatus of claim 15, wherein said positional actuator comprises elongate pneumatic structures, with one pneumatic structure on either side of the mattress, with each said pneumatic structure being filled with air to expand the elongate pneumatic structure, or air released to contract the elongate pneumatic structure, in response to which the mattress panels are moved within the mattress from one stable position to the other, or to retain the mattress in a center position.
